(19) United States
(12) Patent Application Publication
(10) Pub. No.: US 2023/0349315 A1
(43) Pub. Date: Nov. 2, 2023

(54) Method for Operating an Internal Combustion Engine of a Motor Vehicle

(71) Applicant: Mercedes-Benz Group AG, Stuttgart (DE)

(72) Inventors: Maroje MATANA, Stuttgart (DE); Nils BRINKERT, Ludwigsburg (DE)

(21) Appl. No.: 18/041,310

(22) PCT Filed: Jul. 22, 2021
(86) PCT No.: PCT/EP2021/070499

§ 371 Date: Feb. 10, 2023

(30) Foreign Application Priority Data
Aug. 13, 2020 (DE) 10 2020 004 917.6

(51) Int. Cl. F02B 29/04; F02B 37/16; F02B 29/02; F02B 37/18

(52) U.S. Cl. CPC F02B 29/02; F02B 29/0406; F02B 37/162; F02B 37/18

(57) ABSTRACT

A method for operating an internal combustion engine of a motor vehicle. The internal combustion engine includes a combustion chamber, an intake tract, a compressor disposed in the intake tract, and a conduit element which is fluidly connected to the intake tract. The internal combustion engine is operable in a heating mode to heat at least a compressor housing of the compressor. In the heating mode a part of the air flowing through the intake tract and compressed by the compressor is returned to the intake tract by the conduit element. The method includes recording a temperature of the air in the intake tract upstream of the compressor by a sensor and comparing the temperature with a threshold value. When the temperature is lower than the threshold value, the internal combustion engine is operated in the heating mode.

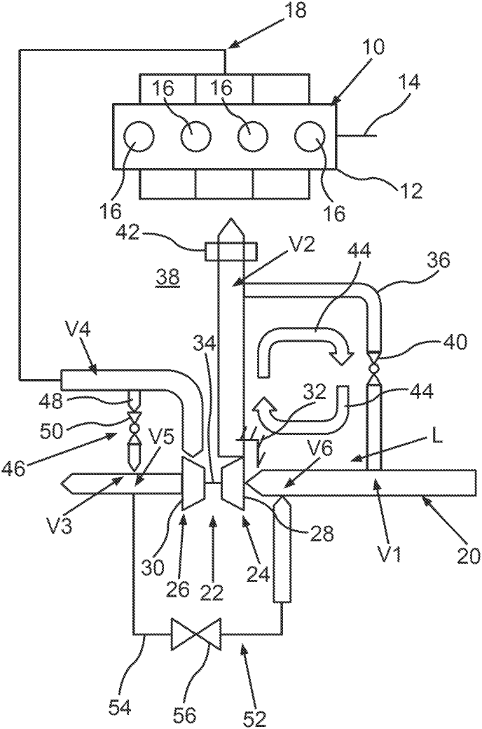

### BACKGROUND AND SUMMARY OF THE INVENTION

The invention relates to a method for operating an internal combustion engine of a motor vehicle.

An Otto internal combustion engine should be taken as known from DE 198 24 476 B4, having an exhaust gas turbocharger whose compressor is arranged in an inlet line of the Otto internal combustion engine and connected in a rotatably fixed manner to a turbine which is arranged in an exhaust gas conduit of the Otto internal combustion engine. The Otto internal combustion engine additionally has a compressor bypass in the inlet line which bypasses the compressor and can be released by a shut-off device that is connected to a control unit via a control conduit for receiving actuating commands depending on the load state of the Otto internal combustion engine. DE 102 58 402 A1 additionally discloses a method for controlling an internal combustion engine. A combustion motor is further known from US 3 018 617 A.

The object of the present invention is to create a method for operating an internal combustion engine such that a particularly advantageous operation of the internal combustion engine can be guaranteed in a particularly simple manner.

The invention relates to a method for operating an internal combustion engine — preferably formed as a reciprocating engine — of a motor vehicle, in particular a motor vehicle in the form of a passenger car. This means that the motor vehicle in its fully manufactured state comprises the internal combustion engine, by means of which the internal combustion engine can be driven, in particular in its fired traction mode. In the method, the internal combustion engine has an intake tract, also referred to as an inlet tract, that can be flowed through by air and via which at least one combustion chamber of the internal combustion engine is or can be provided with the air. This means that the air flowing through the intake tract is or can be fed to and particularly into the combustion chamber by means of the intake tract. As already previously indicated, the internal combustion engine can be operated in a fired mode. The combustion chamber is provided with the air and liquid fuel, in the fired mode, so that a mixture of fuel and air comprising the air and the fuel and also simply referred to as a mixture is formed, in particular in the combustion chamber. The mixture is combusted in the combustion chamber during the fired mode, from which exhaust gas of the internal combustion engine results. The combustion of the mixture thus occurs in the course of a respective combustion process occurring in the combustion chamber, wherein in the fired mode, corresponding combustion processes occur respectively following one after the other in the combustion chamber in the fired mode.

The internal combustion engine can further be operated in a traction mode. In the traction mode, the internal combustion engine is in its fired mode, such that the traction mode is also described as a fired traction mode. In the traction mode, the internal combustion engine provides torques for driving the motor vehicle via its output shaft that is preferably formed as a crankshaft in the traction mode. In other words, the motor vehicle can be driven by means of the internal combustion engine in the fired traction mode. In this traction mode, the output shaft is driven by means of the combustion processes occurring in the combustion chamber. The internal combustion engine can also be operated in a traction mode. The internal combustion engine or the output shaft is driven by at least one wheel of the moving, e.g., rolling motor vehicle in the traction mode or during the traction mode, so that the output shaft is driven by means of kinetic energy of the motor vehicle in the traction mode. It is preferably provided here, for example, that combustion processes occurring in the combustion chamber, particularly in the internal combustion engine as a whole, cease during the traction mode.

The internal combustion engine additionally comprises a compressor arranged in the intake tract, which compressor has a compressor housing and a compressor wheel arranged rotatably on the compressor housing and thus rotatable relative to the compressor housing. The air flowing through the intake tract and to be fed to the combustion chamber can be compressed by means of the compressor wheel. The air compressed by means of the compressor wheel is described as charge air.

The internal combustion engine additionally comprises a conduit element which — as described in more detail in the following — is also referred to as a return conduit or recirculation conduit. The conduit element is fluidly connected to the intake tract at a first connection point and at a second connection point. The first connection point is arranged upstream of the compressor wheel in the flow direction of the air flowing through the intake tract, and the second connection point is arranged downstream of the compressor wheel in the flow direction of the air flowing through the intake tract.

In order to now be able to guarantee a particularly advantageous mode of the internal combustion engine, in particular in the traction mode, in a particularly simple manner, it is provided according to the invention that, in order to heat at least the compressor housing, the internal combustion engine is specifically, i.e., deliberately operated in a heating mode in or during which at least a part of the air flowing through the intake tract and compressed by means of the compressor wheel is removed from the intake tract at the second connection point, introduced into the conduit element, returned to the first connection point by means of the conduit element and introduced into the intake tract at the first connection point. The air can thus circulate from the second connection point to the first connection point via the conduit element and from the first connection point back to the second connection point via the intake tract, wherein the air is compressed (again) by means of the compressor wheel by its path from the first connection point to the second connection point. The air is heated by compressing the air. As at least a part of the air is compressed several times in sequence because the air can circulate via the conduit element, the air can be strongly heated, and as the strongly heated air flows through the compressor and thus through the compressor housing, it is possible to heat at least the compressor housing and preferably also components arranged in an environment of the compressor housing, and thus arranged outside the compressor housing and arranged in close proximity of the compressor housing, e.g., an engine ventilation system of the internal combustion engine and at least one partial region of the intake tract different from the compressor, e.g., formed as a fresh air pipe. The formation of ice upstream of the compressor wheel can thus particularly be avoided without additional and thus more cost-intensive, heavier, separate components which take up more space being required for this purpose.

It is thus particularly the idea of the invention to give the conduit element two purposes. On the one hand, the conduit element is used, for example, as an overrun air recirculation conduit in the overrun mode of the internal combustion engine, via which, for example, an excessive reduction in the rotation speed of the compressor wheel should be avoided, and, for this purpose, air should be returned from the second connection point to the first connection point via the conduit element and introduced into the intake tract upstream of the compressor wheel at the first connection point when a throttle flap arranged in the intake tract and in this case downstream of the second connection point, for example, is at least partially closed and then opened again. On the other hand, the conduit element is used to allow the air to circulate via the conduit element and over the compressor wheel, and thus over a longitudinal region of the intake tract comprising the compressor wheel, in particular in the traction mode of the internal combustion engine. The air and, by means of the air, the compressor housing, can thus be heated and/or kept warm, such that an undesired formation of ice in the compressor housing, and in particular upstream of the compressor wheel, can be avoided. This is particularly advantageous in the event of low ambient or external temperatures, and thus in the event of a low temperature of the air flowing into the intake tract. The compressor housing can thus be heated or kept warm here without additional components, e.g., additional electrical heating elements. This means that it is generally conceivable to use a ventilation system that can be heated up electrically, for example, to heat the compressor housing and/or the air flowing through the intake tract upstream of the compressor housing using electrical energy, for example. This can now be avoided, however, such that formation of ice in the compressor housing can be avoided in a simple, space-saving, cost-effective and weight-saving manner.

In order to be able to operate the internal combustion engine in a manner particularly as required in the heating mode, and thus to be able to heat the compressor housing as needed, and thus keep it warm, such that the internal combustion engine can be operated particularly efficiently overall, it is provided that a temperature of the air upstream of the compressor wheel in the intake tract is recorded by means of a sensor. In other words, it is provided, for example, that a temperature — prevailing in the intake tract upstream of the compressor wheel — of the air received in the intake tract or flowing through the intake tract is recorded by means of the sensor. The recorded temperature is compared with a threshold value also described as a limit value, in particular by means of an electronic computing device. If the temperature is lower than the threshold value, i.e., if it is determined by the comparison of the temperature with the threshold value that the temperature is lower than the threshold value, then the internal combustion engine is operated in the heating mode. The temperature is determined during a first part of the traction mode, for example, wherein the valve element is in the closed position, in particular throughout or without interruption, during the first part of the traction mode, such that the heating mode ceases during the first part of the traction mode. If it is then determined during the first part of the traction mode by the temperature being compared with the threshold value that the temperature is lower than the threshold value, then the valve element is switched out of the closed position into the open position, such that the valve element is in the open position, in particular throughout or without interruption, during a second part of the traction mode following the first part of the traction mode. The heating mode is thus carried out during the second part, for example, in particular without interruption or throughout. An undesired ice formation in and/or on the compressor housing can thus be avoided.

In an advantageous embodiment of the invention, the internal combustion engine comprises a valve element that is arranged in the conduit element, for example, which can be displaced between one closed position and at least one open position. The conduit element is fluidically blocked by means of the valve element in the closed position, whereby no air can be fed through the conduit element in the closed position. This means that no air is returned from the second connection point to the first connection point via the conduit element in the closed position. In the open position, however, the valve element releases the conduit element, such that air can flow through the conduit element in the open position. The valve element is in the open position during the heating mode here. A particularly advantageous mode of the internal combustion engine can be guaranteed as needed by the use of the valve element. The two functions described above thus also apply to the valve element. On the one hand, the valve element is used to return air compressed by means of the compressor wheel, in particular during the overrun mode, from the second connection point to the first connection point via the conduit element and the valve element, and to introduce the air into the intake tract at the first connection point, in particular in the overrun mode and thus preferably as a waste gate valve. An excessive reduction in the speed of rotation of the compressor wheel can thus be avoided, such that the so-called turbo lag can at least be kept particularly low. On the other hand, in the heating mode, and preferably in the simultaneously occurring traction mode, the valve element is used to allow the air to circulate via the conduit element and over the specified longitudinal region of the intake tract in the heating mode and preferably also in the traction mode, and thus to guarantee a sufficiently high temperature of the compressor housing. An excessive ice formation in the compressor housing can thus be avoided.

The valve element is preferably formed to adjust different quantities of air flowing through the conduit element greater than 0. It is thus conceivable, for example, that the valve element can be displaced between the open position and the closed position, and can also be inserted, in particular moved, into at least one further intermediate position different from the open position and the closed position, wherein the valve element also releases the conduit element in the intermediate position. For example, the valve element releases the conduit element more in the intermediate position than in the closed position, but less than in the open position, whereby different quantities of the air flowing through as a conduit element can be adjusted as needed. A strength of the heating of the compressor housing that can be effected by means of the air can thus be adjusted, for example.

As already indicated, it has proved particularly advantageous if the internal combustion engine is in its fired traction mode during the heating mode. The traction mode is particularly understood to mean that combustion processes are occurring in the internal combustion engine or in the combustion chamber, by means of which processes the output shaft is driven and is thus particularly rotated relative to a housing element of the internal combustion engine. A particularly advantageous operation of the internal combustion engine can thus be guaranteed in a particularly simple manner in the traction mode.

A further embodiment is characterized in that an intercooler, by means of which the air compressed by means of the compressor wheel and heated as a result is cooled, is arranged in the intake tract downstream of the compressor wheel. High charging levels can thus be obtained, particularly during the traction mode, such that the internal combustion engine can be operated particularly efficiently, and thus in a manner that uses little fuel.

It has here proved particularly advantageous if the intercooler is arranged downstream of the second connection point. It can thus be avoided that the air circulating over the previously specified longitudinal region of the intake tract and via the conduit element, by means of which the compressor housing is heated or kept warm, is cooled by means of the intercooler, such that the compressor housing can be particularly efficiently and effectively heated, in particular in a traction mode. Contrastingly, the air which passes the second connection point, for example, and is thus guided to the combustion chamber and into the combustion chamber, can be cooled on its way to the combustion engine by means of the intercooler. A particularly advantageous operation of the internal combustion engine can thus be guaranteed in a particularly simple manner.

In a further, particularly advantageous configuration of the invention, the intake tract does not have a cooling device for cooling the air in a longitudinal region extending continuously and thus without interruption from the compressor wheel to the second connection point. The compressor housing can thus be effectively and efficiently heated or kept warm.

Overall, it can be recognized that, for example, a switch is made from a normal mode occurring in particular during the first part of the traction mode, in particular without interruption, into the heating mode, depending on the determined temperature. In other words again, the heating mode is carried out depending on the determined temperature, for example.

An internal combustion engine for a motor vehicle is also disclosed, wherein the internal combustion engine is configured to carry out a method according to the invention according to the invention.

Advantages and advantageous configurations of the method should be seen as advantages and advantageous configurations of the internal combustion engine and vice versa.

Further advantages, features and details of the invention result from the following description of a preferred exemplary embodiment and with reference to the drawing. The features and combinations of features previously specified in the description and the features and combinations of features specified in the following description of the FIGURE and/or shown solely in the single the FIGURE, can be used not only in the respectively specified combinations, but also in other combinations or in isolation, without leaving the scope of the invention.

### BRIEF DESCRIPTION OF THE DRAWING

In the single the FIGURE, the drawing shows a schematic depiction of an internal combustion engine according to the invention for a motor vehicle.

### DETAILED DESCRIPTION OF THE DRAWING

The single the FIGURE shows an internal combustion engine 10 configured as a reciprocating engine of a motor vehicle in a schematic depiction, the motor vehicle preferably being configured as a motor car, in particular as a passenger car, and being able to be driven by means of the internal combustion engine 10, in particular in its traction mode. The motor vehicle has at least one or exactly two axles arranged one after the other in the longitudinal direction of the vehicle, for example. The respective axle has at least or exactly two vehicle wheels spaced apart from each other in the transverse direction, also simply referred to as wheels, for example. At least one of the axles can be driven by means of the internal combustion engine 10 here. By this should particularly be understood that at least the wheels of the at least one axle can be driven by means of the internal combustion engine 10. The vehicle as a whole is driven by driving the wheels. The internal combustion engine 10 has a housing element 12 that is, for example, formed as a ball housing and an output shaft 14 that is, for example, formed as a crankshaft, which can be rotated relative to the housing element 12 around a crankshaft rotation axis. The housing element 12 has several cylinders 16 by which a respective combustion chamber is respectively partially delimited. A piston is received in the respective cylinder 16 in a translationally movable manner, wherein the piston partially delimits the respective combustion chamber. The respective piston is articulatedly connected to the output shaft 14 via a connecting rod, such that translational movements taking place in the respective cylinder 16 and occurring relative to the housing element 12 are transformed into a rotational movement of the output shaft 14. The internal combustion engine 10 is in its fired mode during the previously specified traction mode. In the fired mode, combustion processes occur in the combustion chambers during which a respective mixture of fuel and air is burned in the respective combustion chamber. The pistons are driven by the combustion processes, such that the output shaft 14 is driven by the piston via the connecting rod and is thus rotated around the crankshaft rotation axis relative to the housing element 12. Exhaust gas results from the respective combustion process. The exhaust gas can flow out of the combustion chambers, flow into an exhaust gas tract 18 of the internal combustion engine 10 and flow through the exhaust gas tract 18.

The respective mixture of fuel and air is also referred to as a mixture, and comprises air and a fuel, in particular a liquid fuel, wherein the respective combustion chamber is provided with the air and with the fuel. In this case, the internal combustion engine 10 has an intake tract 20 that can be flowed through by the air and is also referred to as an inlet tract, by means of which intake tract the air flowing through the intake tract 20 is fed to and particularly into the combustion chambers.

The internal combustion engine comprises at least one exhaust gas turbocharger 22 here, which has a compressor 24 arranged in the intake tract 20 and a turbine 26 arranged in the exhaust gas tract 18. The compressor 24 has a compressor wheel 28 arranged in the intake tract 20. The turbine 26 comprises a turbine wheel 30 arranged in the exhaust gas tract 18. The compressor 24 additionally comprises a compressor housing 32 depicted only schematically and partially in the FIGURE, in which the compressor wheel 28 is rotatably received. The compressor wheel 28 and the turbine wheel 30 are rotors. The exhaust gas turbocharger 22 also comprises a shaft 34 here. The turbine wheel 30 can be driven by the exhaust gas flowing through the exhaust gas tract 18, and can thus be rotated around a rotor rotation axis relative to the compressor housing 32. The compressor wheel 28 can be driven by the turbine wheel 30 via the shaft 34 here, and thus around the rotor rotation axis relative to the compressor housing 32. The air flowing through the intake tract 20 is thus compressed by means of the compressor wheel 28. Energy contained in the exhaust gas can thus be used to compress the air.

The internal combustion engine 10 additionally comprises a conduit element 36 which is fluidly connected to the intake tract 20 at a first connection point V1 and at a second connection point V2. The connection point V2 is arranged downstream of the connection point V1 in the flow direction of the air flowing through the intake tract 20, and the connection point V1 is additionally arranged upstream of the compressor wheel 28, while the connection point V2 is arranged downstream of the compressor wheel 28. A method for operating the internal combustion engine 10, particularly in the traction mode, is described in the following with reference to the single the FIGURE

In order to be able to guarantee a particularly advantageous operation of the internal combustion engine 10, particularly during the traction mode, in a particularly simple manner, the internal combustion engine 10 is operated in a heating mode to heat at least the compressor housing 32, particularly during at least a part of the traction mode, the heating mode thus being carried out simultaneously with the traction mode at least during the specified part, for example. In other words, it is preferably provided that the internal combustion engine 10 is in the traction mode during the heating mode. In the traction mode, at least a part of the air flowing through the intake tract 20 and compressed, and thus warmed, by means of the compressor wheel 28 is removed from the intake tract 20 at the second connection point V2, introduced into the conduit element 36, returned to the first connection point V1 by means of the conduit element 36 and introduced into the intake tract 20 at the first connection point V1. The air can then flow from the connection point V1 back to the connection point V2. The air flows through the compressor housing 32 on its way from the connection point V1 to the connection point V2, such that the compressor housing 32 is heated or kept warm by means of the returned air that has already previously been compressed, and thus heated. The air is additionally compressed again on its way from the connection point V1 and the connection point V2 by means of the compressor wheel 32, and is thus heated further, whereby a particularly high temperature of the air flowing from the connection point V1 to the connection point V2, and flowing through the compressor housing in the process, can thus be obtained. The compressor housing 32 and the component arranged in an environment 38 of the compressor housing 32 can thus be kept warm or heated efficiently and effectively with the internal combustion engine 10.

The internal combustion engine 10 has a valve element 40 arranged in the conduit element 36 here, the valve element being able to be displaced between a closed position blocking the conduit element 36 and at least one open position releasing the conduit element 36. The valve element 40 is in the open position during the heating mode here. It is preferably provided that the valve element 40 is in the closed position at least during a different part of the traction mode from the heating mode. The valve element 40 is constantly in the closed position during the traction mode, with the exception of the heating mode occurring during the traction mode.

An intercooler 42 depicted particularly schematically in the FIGURE is arranged in the intake tract 20 downstream of the compressor wheel 28, by means of which intercooler the air compressed by means of the compressor wheel 28 can be cooled. The intercooler 42 is arranged downstream of the connection point V2 here, such that the air is not cooled by means of the intercooler 42 on its way from the connection point V1 to the connection point V2 and from the connection point V2 back to the connection point V1.

A circulation of the air is depicted in the FIGURE by arrows 44. The circulation takes place during the heating mode here. It can particularly be seen with reference to the arrows 44 that the air circulates via the conduit element 36 and over a longitudinal region L of the intake tract 20 during the heating mode, wherein the longitudinal region L extends exactly from the connection point V1 all the way, and thus without interruption, to exactly the connection point V2, wherein the compressor 24 is arranged in the longitudinal region L. Circulation should particularly be understood to mean that the air flows from the connection point V2 to the connection point V1 via the conduit element 36, and back from the connection point V1 to the connection point V2. A particularly high temperature of the circulating air can be obtained by this circulation, whereby the compressor housing 32 can be heated or can be kept warm effectively and efficiently.

It can further be seen from the FIGURE that the longitudinal region L of the intake tract 20 extending from the connection point V1 all the way to the connection point V2 does not have a cooling device for cooling the air. It can be seen that the compressor housing 32 and parts bordering or connected to it can be heated and kept warm by the method, particularly during cold ambient conditions, such that an excessive formation of ice can be avoided, particularly upstream of the compressor wheel 28. Damage to the compressor wheel 28 caused by ice can thus be avoided without a separate, additional heating device having to be used.

The turbine 26 is arranged in a bypass device 46, which has a bypass conduit 48 also referred to as a bypass. The bypass conduit 48 is fluidly connected to the exhaust gas tract 18 at a third connection point V3 and at a fourth connection point V4. The connection point V4 is arranged upstream of the turbine wheel 30 in the flow direction of the exhaust gas flowing through the exhaust gas tract 18, while the connection point V3 is arranged downstream of the turbine wheel 30. At least a part of the exhaust gas flowing through the exhaust gas tract 18 can be removed from the exhaust gas tract 18 at the connection point V4 by means of the bypass conduit 48 and introduced into the bypass conduit 48. The exhaust gas removed at the connection point V4 and introduced into the bypass conduit 48 can flow through the bypass conduit 48 and is guided to the connection point V3 by means of the bypass conduit 48. The exhaust gas flowing through the bypass conduit 48 can be introduced into the exhaust gas tract 18 again at the connection point V3, wherein the exhaust gas flowing through the bypass conduit 48 bypasses the turbine wheel 30, and thus does not drive the turbine wheel 30.

The bypass device 46 additionally comprises a valve 50, also referred to as a bypass valve, waste gate or waste gate valve, arranged in the bypass conduit 48, by means of which a quantity of the exhaust gas flowing through the bypass conduit 48 can be adjusted, for example. A power of the turbine 26 can be adjusted as needed by adjusting the quantity of the exhaust gas flowing through the bypass conduit 48.

The internal combustion engine 10 additionally has an exhaust gas recirculation device 52 having an exhaust gas recirculation conduit 54. The exhaust gas recirculation conduit 54 is fluidly connected to the exhaust gas tract 18 at a fifth connection point V5 and fluidly connected to the intake tract 20 at a sixth connection point V6. The connection point V6 is arranged upstream of the compressor wheel 28, and preferably downstream of the connection point V1 in the flow direction of the exhaust gas flowing through the intake tract 20, for example. The connection point V5 is arranged downstream of the turbine wheel 30 in the flow direction of the exhaust gas flowing through the exhaust gas tract 18, for example, wherein the connection point V5 can be arranged upstream or downstream of the connection point V3. At least a part of the exhaust gas flowing through the exhaust gas tract 18 can be removed from the exhaust gas tract 18 at the connection point V5 by means of the exhaust gas recirculation conduit 54 and introduced into the exhaust gas recirculation conduit 54. The exhaust gas removed from the exhaust gas tract 18 at the connection point V5 and introduced into the exhaust gas recirculation conduit 54 can flow through the exhaust gas recirculation conduit 54, and is fed, and thus returned, to the connection point V6 by means of the exhaust gas recirculation conduit 54. The exhaust gas flowing through the exhaust gas recirculation conduit 54 can flow out of the exhaust gas recirculation conduit 54 at the connection point V6, and flow into the intake tract 20. The exhaust gas recirculation device 52 comprises an exhaust gas recirculation valve 56 arranged in the exhaust gas recirculation conduit 54 here, by means of which a quantity of the exhaust gas flowing through the exhaust gas recirculation conduit 54 can be adjusted.

List of reference characters:

| | |
|---|---|
| 10 | internal combustion engine |
| 12 | housing element |
| 14 | output shaft |
| 16 | cylinder |
| 18 | exhaust gas tract |
| 20 | intake tract |
| 22 | exhaust gas turbocharger |
| 24 | compressor |
| 26 | turbine |
| 28 | compressor wheel |
| 30 | turbine wheel |
| 32 | compressor housing |
| 34 | shaft |
| 36 | conduit element |
| 38 | environment |
| 40 | valve element |
| 42 | intercooler |
| 44 | arrow |
| 46 | bypass device |
| 48 | bypass conduit |
| 50 | bypass valve |
| 52 | exhaust gas recirculation device |
| 54 | exhaust gas recirculation conduit |
| 56 | exhaust gas recirculation valve |
| V1 | connection point |
| V2 | connection point |
| V3 | connection point |
| V4 | connection point |
| V5 | connection point |
| V6 | connection point |

1-8. (canceled)

9. A method for operating an internal combustion engine (10) of a motor vehicle, the internal combustion engine (10) comprising:
a combustion chamber;
an intake tract (20), wherein air is flowable through the intake tract (20) and wherein the combustion chamber is providable with the air via the intake tract (20);
a compressor (24) disposed in the intake tract (20), wherein the compressor (24) has a compressor housing (32) and a compressor wheel (28) disposed rotatably in the compressor housing (32) for compressing air flowing through the intake tract (20) and to the combustion chamber; and
a conduit element (36) which is fluidly connected to the intake tract (20) at a first connection point (V1) disposed upstream of the compressor wheel (28) and at a second connection point (V2) disposed downstream of the compressor wheel (28);
wherein the internal combustion engine (10) is operable in a heating mode to heat at least the compressor housing (32) and wherein in the heating mode at least a part of the air flowing through the intake tract (20) and compressed by the compressor wheel (28) is removed from the intake tract (20) at the second connection point (V2), introduced into the conduit element (36), provided to the first connection point (V1) by the conduit element (36) and introduced into the intake tract (20) at the first connection point (V1);
and comprising the steps of:
recording a temperature of the air in the intake tract (20) upstream of the compressor wheel (28) by a sensor;
comparing the temperature with a threshold value; and
when the temperature is lower than the threshold value, operating the internal combustion engine (10) in the heating mode.

10. The method according to claim 9, wherein the internal combustion engine (10) further comprises a valve element (40) which is displaceable between a closed position that blocks the conduit element (36) and an open position that releases the conduit element (36) and wherein the valve element (40) is in the open position during the heating mode.

11. The method according to claim 9, wherein the internal combustion engine (10) is in a traction mode during the heating mode.

12. The method according to claim 9, wherein the internal combustion engine (10) further comprises an intercooler (42) disposed in the intake tract (20) downstream of the compressor wheel (28) and wherein air compressed by the compressor wheel (28) is cooled by the intercooler (42).

13. The method according to claim 12, wherein the intercooler (42) is disposed downstream of the second connection point (V2).

14. The method according to claim 9, wherein the intake tract (20) does not have a cooling device for cooling the air in a longitudinal region (L) extending continuously from the compressor wheel (28) to the second connection point (V2).
